(19) United States
(12) Patent Application Publication
(10) Pub. No.: US 2004/0034933 A1
(43) Pub. Date: Feb. 26, 2004

(54) Auto-locating procedural lights using a hospital bed

(76) Inventors: Mitchell A. Smith, Cincinnati, OH (US); Ernestine K. Johnson, Cincinnati, OH (US); Jackie Smith, Edmond, OK (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/462,186

(22) Filed: Jun. 16, 2003

Related U.S. Application Data
(60) Provisional application No. 60/388,710, filed on Jun. 14, 2002.

(51) Int. Cl. A61G 13/10

(52) U.S. Cl. 5/602; 5/905

(57) ABSTRACT

A patient support lighting system for use with a patient support and including a light fixture configured to be automatically positioned based upon the location of the patient support.

### CROSS-REFERENCE TO RELATED APPLICATION

This application claims the benefit of U.S. Provisional Patent Application Serial No. 60/388,710, filed Jun. 14, 2002.

### BACKGROUND AND SUMMARY OF THE INVENTION

The present invention relates to procedural lights of the type utilized in hospitals. More particularly, the present invention relates to procedural lights including a remote sensor or locator on which to aim.

According to an illustrative embodiment of the present invention, a patient support lighting system is disclosed. The lighting system includes a patient support, a transmitter coupled to the patient support, and a detector located at a distance from the transmitter. The lighting system also includes an actuator in communication with the receiver and a light coupled to the actuator. The transmitter is configured to communicate a signal to the detector and the actuator is configured to be controlled in response to the signal. More particularly, the actuator is configured to position the light based upon the received signal.

According to a further illustrative embodiment of the present invention, a patient support locating system is disclosed. The locating system includes a patient support, a transmitter coupled to the patient support, a detector located at a distance from the transmitter, and an accessory in communication with the detector. The transmitter is configured to communicate a signal to the detector and the detector is configured to communicate patient support position information to the accessory.

According to another illustrative embodiment of the present invention, a patient support light system is disclosed. The light system includes a patient support, a transmitter coupled to the patient support, a light, and means for aiming the light at the transmitter.

According to a further illustrative embodiment of the present invention, a method of locating a patient support is disclosed. The method includes the steps of transmitting a signal from a first point on the patient support, receiving the signal at a second point spaced apart from the first point, and determining the position of the first point.

According to yet another illustrative embodiment of the present invention, a patient support is provided including a foot pedal. The foot pedal is configured to control a light.

Additional features of the present invention will become apparent to those skilled in the art upon consideration following detailed description of illustrated embodiments exemplifying the best mode of carrying out the invention as presently perceived.

### BRIEF DESCRIPTION OF THE DRAWINGS

The detailed description refers to the accompanying figures in which:

FIG. 1 is a perspective view of the lighting system of the present invention used in combination with a birthing bed showing a removable foot section fully inserted into the bed and latched to the patient support, the foot section extending generally horizontally in the plane of the patient support, and further showing a head section raised to a reclining position;

FIG. 2 is a perspective view of the lighting system of the present invention used in combination with a birthing bed similar to FIG. 1, but showing the foot section detached from the seat section;

FIG. 3 is a perspective view of the underside of the cushion of the seat section of the birthing bed of FIG. 1;

FIG. 4 is a block diagram illustrating the lighting system of the present invention; and

FIG. 5 is a block diagram illustrating an RFID tag and detector of the present invention.

### DETAILED DESCRIPTION OF THE DRAWINGS

The present invention will be described below primarily as a lighting system for use with a birthing or delivery bed, but it should be understood that the same may be used in conjunction with any other patient support apparatus, such as a hospital stretcher, an examination table, hospital bed, or an operating table.

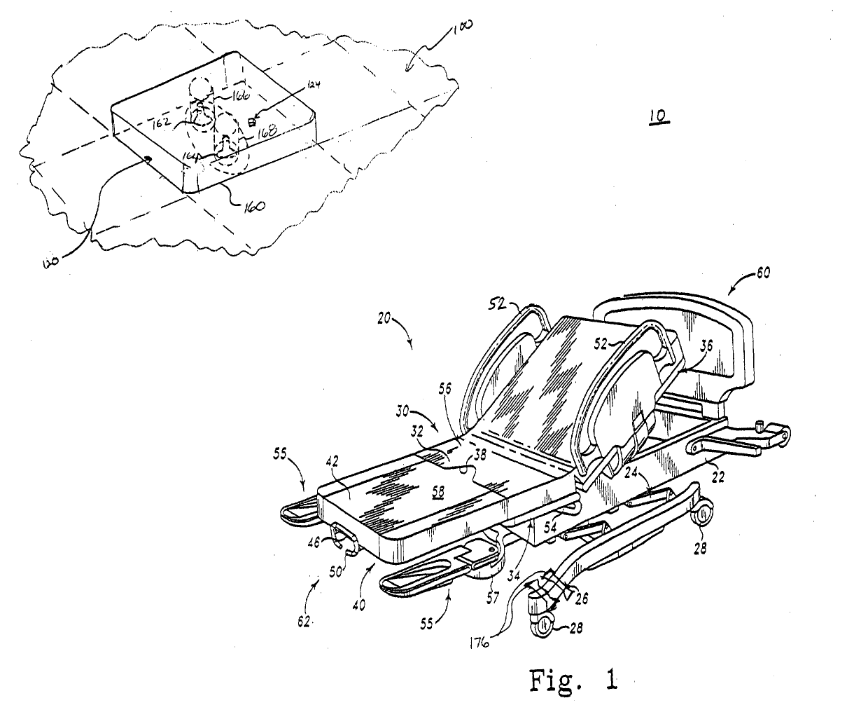

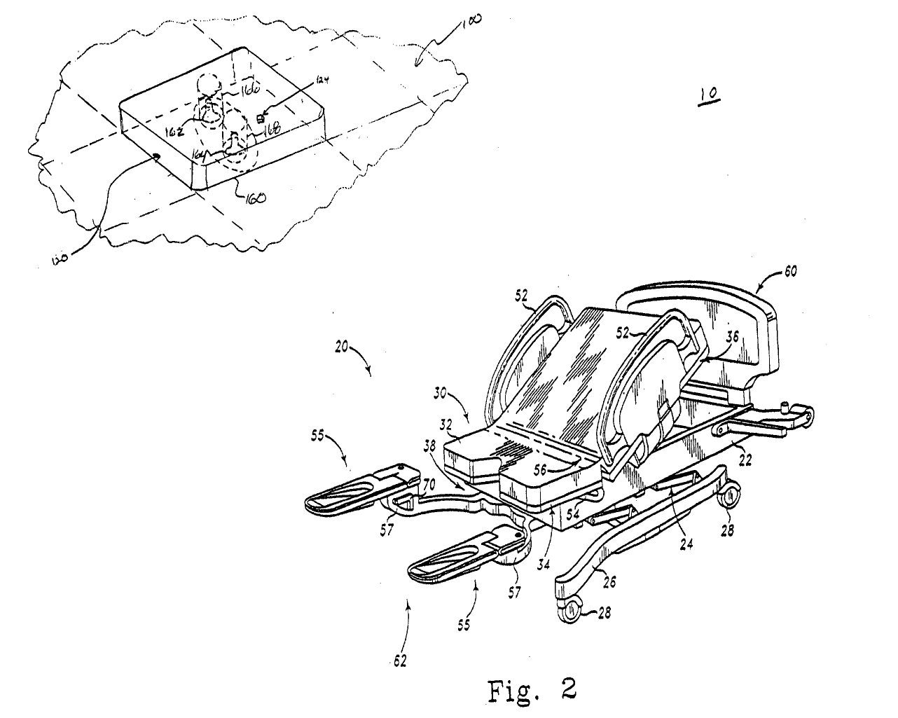

Referring to FIGS. 1 and 2, an illustrative birthing bed 20 is shown in a conventional hospital room 10, the bed 20 having a main frame 22 mounted by a parallelogram linkage 24 to a base frame 26. The base frame 26 has casters 28 for supporting the bed 20 on the floor. The bed 20 includes a patient support deck 30 for supporting a mattress 56 on which a patient can rest. The patient support deck 30 includes a generally horizontal seat section 34 coupled to the main frame 22. A head section 36 is pivotally coupled to the seat section 34 so that the bed 20 can be articulated between a generally horizontal lying-down position defining a generally horizontal, upwardly-facing surface 32 in the plane of the seat section 34, a generally reclining sitting-up position with the head section 36 inclined with respect to the seat section 34, and a number of intermediate positions therebetween (FIGS. 1 and 2).

The seat section 34 includes a central opening 38 into which a removable foot section 40 is inserted such that an upper surface 42 of the foot section 40 extends generally horizontally in the plane of the patient support surface 32 when the foot section 40 is fully inserted into the central opening 38 and latched to the seat section 34. A detachable portion 58 of the mattress 56 is secured to the foot section 40 by any suitable means—such as a plurality of hook and loop (i.e. Velcro®) fasteners, snaps, ties or the like. Upper surface 42 of foot section 40 is illustratively configured to be aligned in substantially the same plane as seat section 34 of patient support 30 only when the foot section 40 is fully inserted and latched.

The foot section 40 includes a pair of handles (not shown), one on each side, adjacent to a foot end 46 of the foot section 40. The handles assist the caregiver to pull the foot section 40 away from the bed 20 so that the foot section 40 is detached from the patient support deck 30 and stored. The foot section 40 includes a floor stand 50 adjacent to the foot end 46 for vertically supporting the foot section 40 on the floor. As used in this description with reference to the bed 20, the phrase “head end” will be used to denote the end of any referred-to object that is positioned to lie nearest the head end 60 of the bed 20, and the phrase “foot end” will be used to denote the end of any referred-to object that is positioned to lie nearest the foot end 62 of the bed 20.

The head section 36 has two siderails 52 mounted thereon, one on each side of the head section 36. Mounted to the underside of the seat section 34 are labor grips 54, one on each side of the bed 20. The labor grips 54 have two principal positions—a vertical operative position projecting substantially perpendicularly to the seat section 34, and a horizontal out-of-the-way storage position tucked underneath the seat section 34 as illustrated in FIGS. 1 and 2. In their vertical operative positions, the labor grips 54 can be gripped by the mother to assist her in generating maximum thrust during delivery. A pair of pivotable foot supports 55 are coupled to supports 57. Additional details of the bed 20 are disclosed in U.S. Patent Application Serial No. 60/325,690, filed Sep. 28, 2001, which is assigned to the assignee of the present invention and is expressly incorporated herein by reference. As noted above, it should be appreciated that other types of patient supports may find equal applicability with the present invention.

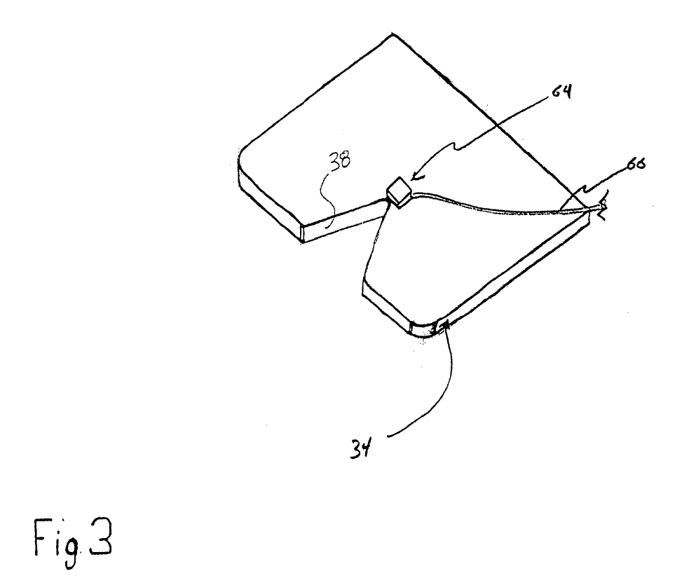

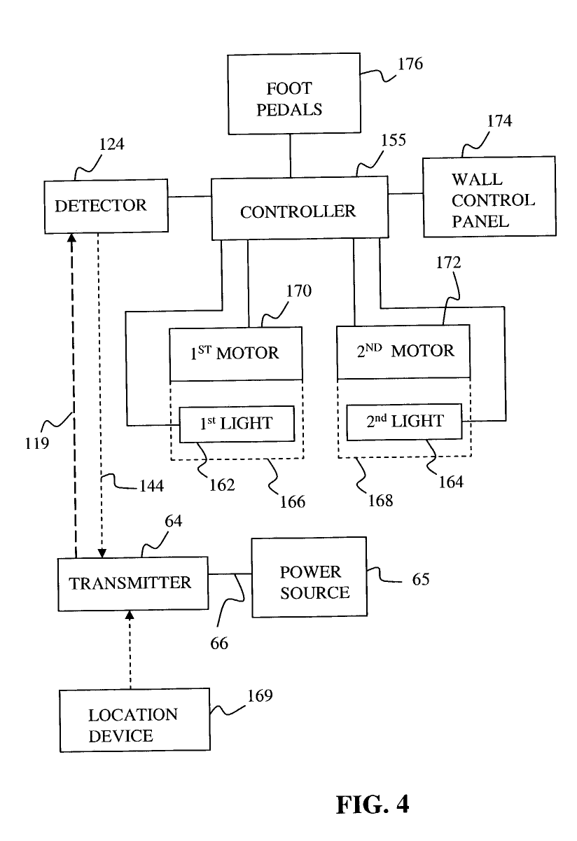

Mounted to the underside of the mattress 56 of the seat section 34 is a locator, illustratively a transmitter 64 connected to an external power source 65 by a cord 66 as shown in FIG. 3. Alternatively, as detailed below, an internal power source such as a battery may be used. In a further illustrative embodiment as detailed below, no power source is directly connected to the transmitter 64. The transmitter 64 is illustratively a radio frequency transmitter (hereinafter referred to as an “RF transmitter”). However, the transmitter 64 may comprise any transmitter, such as an infrared transmitter (hereinafter referred to as an “IR transmitter”) or an ultrasonic transmitter, that sends signals 119 (FIG. 4) to a lighting fixture 120, including a detector or receiver 124 illustratively mounted in the ceiling 100 of the room 10. The RF transmitter 64 set to a proper frequency is able to transmit signals 119 through the seat section 34, other parts of the bed 20, parts of the lighting fixture 120, and most other objects that would hinder a transmittal system that requires a clear line of sight between the transmitter 64 and the detector 124. Due to the ability of the RF transmitter 64 to transmit through many solid objects, it may be desirable to limit the strength of the signal 119 produced by the transmitter 64. A controlled strength signal 119 will prevent the transmitter 64 from communicating with detectors 124 associated with beds 20 in the same or adjacent rooms 10.

In settings where multiple birthing rooms 10 are in close proximity, it is desirable that the bed 20 be configured to be moved into any one of the rooms 10 and for the lighting fixture 120 in each room 10 to properly function therewith. Therefore, it is preferable that all transmitters 64 and detectors 124 utilize the same frequency signals 119 such that the transmitters 64 work with all the detectors 124 and thus necessitating the limited signal strength. Alternatively, embodiments are envisioned where each transmitter 64 has a unique identifier to pair it with a specific detector 124, thereby eliminating the possibility of receiver confusion. Such unique identifiers may be statically or dynamically assigned and associated with the signal 119 sent by each transmitter 64. In yet another embodiment, transmitters 64 are paired with detectors 124 by using a set transmission frequency. Thereby, other transmitter 64 and detector 124 pairs utilize different transmission frequencies to eliminate confusion and cross talk.

In one illustrative embodiment of the invention, the transmitter 64 is formed as part of a tag 128. More particularly, the tag 128 may comprise a radio frequency identification device (hereinafter an “RFID device”) (either active or passive) for providing the data to the detector or receiver 124 as described below. Such RFID devices are produced, for example, by Intermec Technologies Corporation of Everett, Wash. RFID tags 128 may be configured for read-only operation, volatile read/write operation, or write once/read many (WORM) operation. Such tags 128 do not require contact or line-of-sight reading.

As shown in FIG. 4, active RFID tags 128 illustratively include a transceiver 130 (which includes the transmitter 64 as identified above and a receiver), an antenna 132, and a battery 134 to provide power to transceiver 130. The tag 128 may further include a memory 136 to store data relating to the bed 20, and modulation circuitry 138 to provide a tag signal 119 conveying such information as further described below. In an alternate embodiment, active RFID tags 128 may further include a conventional power savings circuit 142 that interrupts or reduces the supply of power to the tag components when the tag 128 remains inactive (does not transmit or receive information) for a predetermined period of time. The tag 128 remains in this power savings mode until it next receives a signal 144 from the detector 124 as further described below.

Passive RFID tags 128 may include similar components. Typically, passive RFID tags 128 reflect RF signals received from detectors 124, and add information relating to the bed 20. More specifically, when tag 128 comes with range of a detector 124, the tag's antenna 132 receives an RF detector signal 144 transmitted by the detector 124. The signal 144 may also be used to provide power to the tag 128 as is well-known in the art. Thus, passive RFID tags 128 may not include a battery 134. The battery 134 may, however, be included in passive RFID tags 128 to provide power to the tag memory 136 (if any), or to the modulation circuitry 138. After the detector signal 144 is received, the tag modulation circuitry 138 encodes the tag signal 119 with the desired information (such as a bed identifier, bed locator information, etc.). The tag signal 140 is then transmitted back to the detector 124 either via the same antenna 132 that received the detector signal 144, or via another transmission antenna included on the tag 128.

Tags 128 may be packaged in a variety of ways. For example, tags 128 (including the transceiver 130, antenna 132, and any other components) may be enclosed within a container, case, or package adapted for attachment to the bed 20 using adhesive, clips, or any other suitable attachment method. Alternatively, tags 128 may be incorporated into a label for application (via adhesive or some other suitable attachment method) to the bed 20. Such labels may be printed using special printers, such as those produced by Zebra Technologies of Vernon Hills, Ill., that employ printing technology similar to that employed by conventional bar-code printers. Since the tags 128 do not require line-of-sight reading, it may be appreciated that they may be embedded within a component of the bed 20, such as within the interior of the mattress 56.

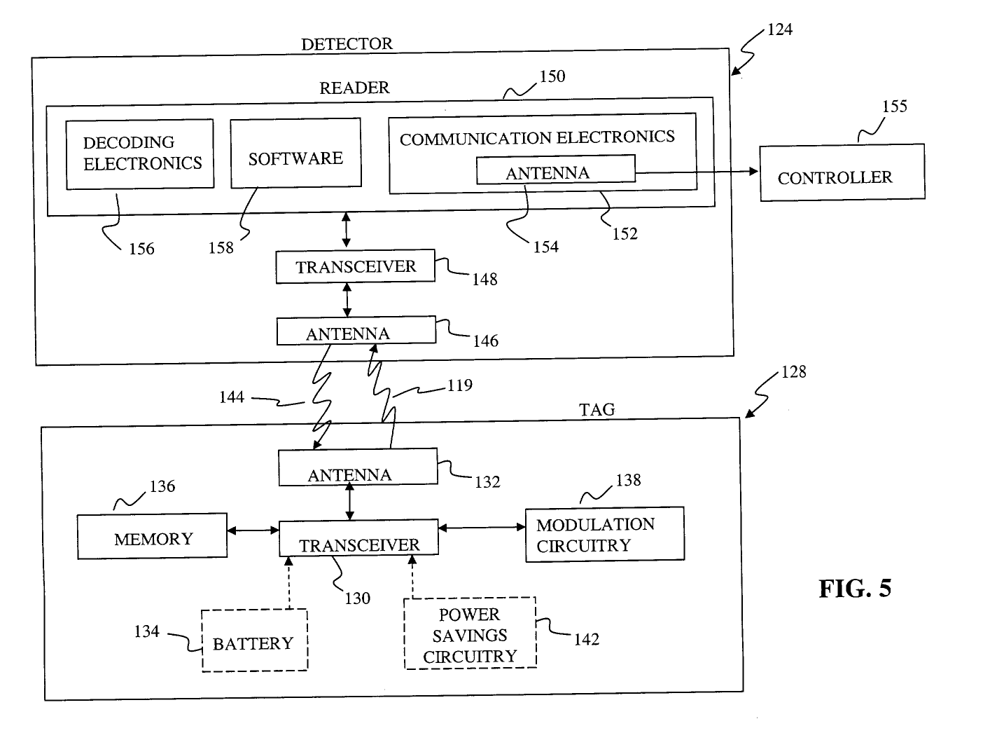

The detector 124 for use with RFID tags 128 generally includes an antenna 146, a transceiver 148, a reader 150, and communication electronics 152 including an antenna 154 for wirelessly communicating with a controller 155 (FIGS. 4 and 5). Of course, communication electronics 152 could alternatively be hardwired to the controller 155. The transceiver 148 transmits the RF energy of detector signal 144 to activate passive tags 128 (or active tags 128 in power savings mode) and power the response transmission (tag signal 140) from passive tags 128. Generally, the transceiver 148 is coupled to the antenna 146 and the reader 150. The antenna 146 generates an electrical field defining the range of detector 124. As will be further described below, the detector 124, including the antenna 146, may be incorporated into the ceiling of the room 10, or a variety of other structural elements or pieces of equipment.

The detector reader 150 controls the transmission of detector signals 144 by the transceiver 130 and the antenna 132, and receives and processes the tag signal 140 from the tag 128 as received by antenna 146 and transceiver 148. The reader 150 includes the communication electronics 152, decoding electronics 156 for decoding the information included in tag signals 140, and software 158. The decoded information is provided to communication electronics 152 for transmission to, for example, the controller 155. The software 158 may implement anti-collision algorithms as are commonly known in the art to permit substantially simultaneous reception, and distinguishing of, multiple tag signals 140.

Referring further to FIGS. 1 and 2, the lighting fixture 120 is illustratively recessed above the ceiling 100. The fixture 120 may be sized to fit in a typical drop ceiling tile slot 160. The fixture 120 includes two adjustable lights 162 and 164 received in housings 166 and 168, respectively, and which communicate with the detector 124. Alternatively, the lights 162 and 164 are separated to reside in separate ceiling slots 160 to provide greater spacing between the lights 122. Further, the lighting fixture 120 may be placed within a conventional solid ceiling. As detailed above with respect to the RFID tag embodiment, the receiver 124 is preferably a radio frequency receiver capable of receiving signals from the transmitter 64.

In alternative embodiments, the fixture 120 includes more than one detector 124 to aid in the locating of the signal 119 source, the transmitter 64. In multi-detector 124 embodiments, the individual receivers 124 are placed at a known distance from each other to receive a simple “ping” or other signal 119 sent from the transmitter 64. Measuring the difference in time between when each detector 124 receives the signal 119 allows the position of the transmitter 64 to be determined, illustratively through a conventional triangulation method implemented by the controller 155. Alternatively, the transmitter 64 can send location information, or adjustment information to the detector 124 provided that the transmitter 64 is able to provide reference points that the detector 124 can interpret. In such an embodiment, a separate bed 20 location device 169 is utilized, such as a pressure sensitive floor surface or mat, and the output information from the location device is communicated to the transmitter 64 to be sent to the detector 124. The pressure sensitive floor mat is of conventional design and detects the location of the casters 20 of the bed 20. The location device 169 may be connected to the transmitter through conventional means, such as wiring or a wireless communication link.

As shown in FIG. 5, the adjustable lights 162 and 164 illustratively have motors 170 and 172 linked to the detector 124 via the controller 155. The motors 170 and 172 allow the housings 166 and 168, and thus the lights 162 and 164 therein, to be moved so as to aim the lights 162 and 164 at a desired location. The lights 162 and 164 illustratively include adjustable lenses (not pictured) such that the focus point of the lights can be set to different lengths. It should be appreciated that the adjustable focus length could also be brought about through a lens that is stationary relative to the housing 166 and 168 and a light 162 and 164 that moves relative to the housing 166 and 168. The lights 162 and 164 are also variable in intensity such that focal distances that are longer can be paired with increased intensity light compared to shorter focal distances for purposes of providing a consistent lighting environment. The lighting fixture 120 preferably has a large angle of coverage through which the lights 162 and 164 may travel. Movement of the lights 162 and 164 through the coverage angle is facilitated by the motors 170 and 172 and assemblies (not shown) that hold housings 166 and 168 of the lights 162 and 164. The assemblies have multiple degrees of motion, such as provided by a conventional gimble assembly, to allow a large field on which the lights may focus. The assemblies may be of the type or similar to assemblies shown in U.S. Pat. No. 4,712,167, U.S. Pat. No. 5,526,245, and U.S. Pat. No. 4,890,207, the disclosures of which are expressly incorporated herein by reference.

In operation, the foot section 40 is removed from the seat section 34 to expose the central opening 38. The central opening 38 illustratively defines a V-cut, as shown in FIG. 2, for increased patient access but may define a straight edge. A mother seated upon the bed 20 has her perineum positioned above the central opening 38 to provide the caregiver added room. Additionally, when treating a delivering mother, the perineum is the area of concentration for the caregiver, therefore the area must be well illuminated. To this end, the transmitter 64 is illustratively located on the underside of the seat section 34 adjacent to the apex of the V-cut central opening 38, approximately beneath the perineum of the mother supported on the bed 20. As previously discussed, the transmitter 64 communicates with the detector 124 and relays the position of the transmitter 64 relative to the detector 124. The transmitter 64 is in constant communication with the detector 124 to re-focus the lights 122 without caregiver intervention. Alternatively, the transmitter 64 sends either intermittent “pings” or locating signals to the detector 124 at predetermined time increments that also re-focus the lights 122 without caregiver intervention.

Also, embodiments are envisioned where the transmitter 64 sends either “pings” or locating signals 119 to the detector 124 when the caregiver activates a switch which may be supported on the bed 20 or coupled to a wall control panel 174. The controller 155 in communication with the detector 124 processes the location information to control the motors 170 and 172 to adjust the housings 166 and 168 and the lights 162 and 164 to focus the lights 122 as instructed. Therefore, if the bed 20 is moved, the transmitter 64 sends the movement information and re-aims and re-focuses the lights 162 and 164 above the central opening 38.

In the above-identified embodiment including a location device 169, such as a pressure sensitive floor mat, the transmitter 64 may send signals 119 to the detector 124 when the location device 169 senses a change in position of the bed 20. The controller 155 then processes the information from the signals 119 as detailed above in order for the lights 162 and 164 to track the relative position of the transmitter 64 on the bed 20.

In addition to the switch to send locating signals, switches are illustratively attached to the base frame 26 that control other properties of the lights 162 and 164 or other objects in the room 10. Illustratively, the switches are foot activated, for example through one or more pedals 176, so as to not require a caregiver to occupy his or her hands to activate the switch. Alternatively, the switches may be supported elsewhere on the bed 20, including the siderails 52. The switches may control the brightness of the lights 162 and 164, provide fine tuning of the focal location of the lights 162 and 164, and hold the position of the lights 162 and 164. In alternative embodiments the switches controlling the functions such as brightness, fine tuning, and master power, may be coupled to the wall control panel 174. Embodiments are also envisioned in which functions are controlled by an on bed switch and a wall panel cooperatively. The switches illustratively may comprise simple on/off switches, multiple setting switches, joysticks, keypads, or any other switch typically used in the art. In other embodiments, beds 20 are provided with multiple transmitters 64, and the switches cycle the focus of the lights 122 from one transmitter 64 to the next.

While FIG. 3 illustrates a single transmitter 64 supported by the seat section 34, in alternative embodiments of the invention a plurality of transmitters 64 are supported by the bed 20. More particularly, the transmitters 64 are arranged in a substantially horizontal plane within an array on the bed 20. Control switches in the wall panel 174 may be manipulated by the user to cause the lights 162 and 164 to focus on any one of the selected transmitters 64.

While the lighting fixture 120 has been described as being recessed above the ceiling 100 to provide an economy of space, lighting fixtures 120 may be attached to the ceiling 100 so as to extend below the ceiling 100. The recessed fixture 120 is preferable for low ceiling height applications such as Labor-Delivery-Recovery areas, Intensive Care Units, and Cardiac Catheter Labs. Other embodiments of the present invention are envisioned where the lighting fixture 120 is affixed to a wall of the room 10.

Other uses for the bed 20 with the transmitter 64 are envisioned that allow the transmitter 64 and the bed 20 to be located. These uses include, but are not limited to, giving the transmitter 64 a unique identifier such that the bed can be easily located in an environment with many detectors 124 which may also have unique identifiers and allowing the transmitter 64 to relay information such as calls for a nurse.

Therefore, a lighting system 120 is provided that tracks and automatically focuses lights 122 on an area of bed 20 where increased illumination is known to be advantageous.

It should be appreciated that one reason that auto-locating is desirable is that hands-free or automatic operation is beneficial for infection control, cleanliness and convenience.

Although the invention has been described in detail with reference to certain illustrated embodiments, variations and modifications exist within the scope and spirit of the invention as described and defined in the following claims.

1. A patient support lighting system comprising:
a patient support,
a transmitter coupled to the patient support,
a detector located at a distance from the transmitter,
a first actuator in communication with the detector, and
a first light coupled to the first actuator, the transmitter configured to communicate a signal to the receiver, the detector configured to communicate the signal to the first actuator, and the first actuator being configured to position the first light based upon the received signal.

2. The patient support lighting system of claim 1, wherein the orientation of the first light is adjusted based upon the signal.

3. The patient support lighting system of claim 1, wherein the first light is adjusted to aim at the transmitter.

4. The patient support lighting system of claim 1, further comprising a second actuator and a second light coupled to the second actuator, the second actuator being configured to position the second light based upon the received signal.

5. The patient support lighting system of claim 4, wherein the first light and second light are adjusted to aim at the transmitter based upon the received signal.

6. The patient support lighting system of claim 1, wherein the transmitter is attached to an underside of the patient support.

7. The patient support lighting system of claim 1, wherein the transmitter communicates light adjustment information.

8. The patient support lighting system of claim 7, wherein a command to adjust the light is input to the transmitter by a caregiver.

9. The patient support lighting system of claim 1, wherein the transmitter communicates with the detector through the use of radio waves.

10. The patient support lighting system of claim 1, wherein the transmitter continuously emits signals to the detector.

11. The patient support lighting system of claim 1, wherein the patient support is a birthing bed, the transmitter is located beneath a seat section of the patient support, and the first light adjusts to aim at the seat section of the patient support.

12. A patient support locating system comprising:
a patient support,
a transmitter coupled to the patient support,
a detector located at a distance from the transmitter, and
an accessory in communication with the detector, the transmitter configured to communicate a signal to the detector and the detector configured to communicate patient support position information to the accessory.

13. The patient support locating system of claim 12, wherein the accessory includes an adjustable light and an actuator configured to control the adjustable light.

14. The patient support locating system of claim 13, wherein the light adjusts to aim at the patient support in response to the signal.

15. The patient support locating mechanism of claim 13, wherein the transmitter communicates light adjustment information.

16. The patient support locating system of claim 15, wherein the light adjustment information is input to the transmitter by a caregiver.

17. The patient support locating system of claim 12, wherein the transmitter communicates with the detector through the use of radio waves.

18. The patient support locating system of claim 12, wherein the transmitter continuously emits a signal for the detector.

19. The patient support locating system of claim 12, wherein the transmitter emits a signal when input is received from a caregiver.

20. The patient support locating system of claim 12, wherein the patient support is a birthing bed, the transmitter is located beneath a seat section of the patient support, and the first light adjusts to aim at the seat section of the patient support.

21. A patient support light system comprising:
a patient support,
a transmitter coupled to the patient support,
a light, and
means for aiming the light at the transmitter.

22. The patient support light system of claim 21, wherein the means for aiming the light includes means for receiving signals from the location transmitter, determining the position of the transmitter, and means for moving the light.

23. The patient support light system of claim 22, wherein the means for receiving signals comprises a plurality of detectors.

24. The patient support light system of claim 21, wherein the transmitter is coupled to the underside of the patient support.

25. The patient support light system of claim 21, wherein the transmitter communicates light adjustment information.

26. The patient support light system of claim 25, wherein the light adjustment information is input to the transmitter by a caregiver.

27. The patient support light system of claim 21, wherein the transmitter communicates with a detector using radio waves.

28. The patient support light system of claim 21, wherein the patient support is a birthing bed, the transmitter is located beneath a perineum of a patient, and the light adjusts to aim at the perineum of the patient.

29. A method of locating a patient support comprising the steps of:
transmitting a signal from a first point on the patient support,
receiving the signal at a second point spaced apart from the first point, and
determining the position of the first point.

30. The method of claim 29, wherein the receiving step includes receiving the signal at a plurality of points.

31. The method of claim 30, wherein the determining step is performed by comparing signals received at the plurality of points.

32. The method of claim 29, further comprising the step of adjusting a light to aim at the patient support.

33. The method of claim 32, wherein the signal includes light adjustment information.

34. The method of claim 33, wherein light adjustment information is input to the transmitter by a caregiver.

35. The method of claim 29, wherein the first point is beneath a seat section of the patient support.

36. The method of claim 29, wherein the signal is in the form of radio waves.

37. The method of claim 29, wherein the signal includes position locating information.

38. A patient support including a transmitter, the transmitter configured to emit a signal receivable by an accessory to allow the accessory to determine the position of the transmitter.

39. The patient support of claim 38, wherein the accessory is a light.

40. The patient support of claim 39, wherein the light receives the signal, determines the position of the transmitter, and the light aims at the transmitter.

41. The patient support of claim 38, wherein the signal includes light adjustment information.

42. The patient support of claim 41, wherein the light adjustment information is input to the transmitter by a caregiver.

43. The patient support of claim 38, wherein the signal is comprised of radio waves.

44. The patient support of claim 38, wherein the patient support is a birthing bed, the transmitter is located beneath a perineum of a patient, and the accessory is a light configured to aim at the perineum of the patient.

45. A patient support including a foot pedal, the foot pedal configured to control a light.

46. The patient support of claim 45, further comprising a transmitter configured to communicate with a receiver coupled to the light.

47. The patient support of claim 46, wherein activation of the foot pedal causes the light to aim at the transmitter.

48. The patient support of claim 45, wherein the foot pedal controls the brightness of the light.

49. The patient support of claim 45, wherein the foot pedal may effect fine tuning of the aim of the light.

50. The patient support of claim 45, wherein the foot pedal acts as an on/off switch for the light.
